(19) United States
(12) Patent Application Publication
(10) Pub. No.: US 2009/0006835 A1
(43) Pub. Date: Jan. 1, 2009

(54) ELECTRONIC DEVICE AND CONTROL METHOD THEREOF

(75) Inventor: Jae-woo KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/946,123

(22) Filed: Nov. 28, 2007

(30) Foreign Application Priority Data
Jun. 29, 2007 (KR) 2007-65070

(51) Int. Cl. G06F 15/177

(52) U.S. Cl. 713/2

(57) ABSTRACT

An electronic device is disclosed. The electronic device includes a storage unit in which execution codes including a boot code and an application code are stored, a main memory in which the boot code is loaded, a CPU which performs booting by executing the boot code loaded in the main memory, and executes the application code; and a controller which reads the boot code of the execution codes, loads the boot code to the main memory, and controls the CPU to perform booting if it is determined that the boot code is completely loaded.

### CROSS-REFERENCE TO RELATED APPLICATIONS

This application claims priority under 35 U.S.C. § 119(a) from Korean Patent Application No. 10-2007-0065070, filed on Jun. 29, 2007 in the Korean Intellectual Property Office, the disclosure of which is incorporated herein in its entirety by reference.

### BACKGROUND OF THE INVENTION

1. Field of the Invention

The present general inventive concept relates to an electronic device and a control method thereof, and more particularly, to an electronic device which loads a boot code stored in a flash memory to perform a booting operation, and a control method thereof.

2. Description of the Related Art

A conventional electronic device such as a printer, a mobile phone, a navigation device and a MP3 player employs a relatively small printed circuit board (PCB) and is booted with a proper protocol.

For example, a serial peripheral interface (SPI) is a synchronous serial data transmission protocol between a host processor and peripheral devices. As the SPI has a small number of pins, it is typically used in a small PCB to store a boot code.

If an electronic device which is booted by a conventional SPI receives a booting request signal such as power supply, the electronic device loads a boot code from a SPI flash memory in which execution codes such as a boot code and various application codes such as OS are stored, stores the boot code in an internal memory of small capacity, and performs booting by using the boot code.

The capacity of the internal memory is generally 4k bytes or 8K bytes. If power is supplied, the electronic device loads and stores the execution codes from the SPI flash memory in the internal memory, until the capacity of the internal memory is filled. If the execution codes are stored, the electronic device generates a boot completion signal so as to make a CPU perform booting using the boot code among the execution codes.

If the boot code that is actually used to boot the electronic device is smaller than the capacity of the internal memory, the electronic device loads unnecessary execution codes thereby unnecessarily filling the capacity of the internal memory, lengthening the booting time and causing malfunction due to unnecessary dummy codes.

### SUMMARY OF THE INVENTION

The present general inventive concept provides an electronic device which can load a boot code only actually required to perform a booting operation, thereby reducing booting time, and a control method thereof.

Additional aspects and/or utilities of the present invention will be set forth in part in the description which follows and, in part, will be obvious from the description, or may be learned by practice of the present invention.

The foregoing and/or other aspects and utilities of the present general inventive concept can be achieved by providing an electronic device, including a storage unit in which execution codes including a boot code and an application code are stored, a main memory in which the boot code is loaded, a CPU which performs booting by executing the boot code loaded in the main memory, and executes the application code, and a controller which reads the boot code of the execution codes, loads the boot code to the main memory, and controls the CPU to perform booting if it is determined that the boot code is completely loaded.

The boot code may include a predetermined end code in an end part thereof, and the controller may determine that the boot code is completely loaded if the end code is read.

The end code may be different from the application code executed by the CPU.

The controller may control to reset a system and to make the CPU perform booting if the end code is read.

The controller may communicate with the storage unit and the main memory through a serial peripheral interface (SPI) protocol.

The electronic device may comprise one of a printer, a mobile phone, a storage device and a navigation device.

The foregoing and/or other aspects and utilities of the present general inventive concept can be also achieved by providing a method of controlling an electronic device, including reading a boot code from a storage unit in which execution codes having the boot code and an application code are stored, and loading the boot code to a main memory determining whether the boot code is completely loaded and executing the boot code stored in the main memory if the boot code is completely loaded, and making a CPU perform booting.

The determining whether the boot code is completely loaded may include reading a predetermined end code included in an end part of the boot code.

The end code may be different from the application code.

The performing of the booting may include activating the CPU by resetting a system if the end code is read.

The loading the boot code may include communicating through a serial peripheral interface (SPI) protocol.

The electronic device may include one of a printer, a mobile phone, a storage device and a navigation device.

The foregoing and/or other aspects and utilities of the present invention general inventive concept can be also achieved by providing an electronic device system, including a CPU to execute a boot code from a main memory, and a controller to load the boot code in the main memory and to boot the CPU if an end code of the boot code matches a pre-stored reference end code.

The electronic device system of claim may further include a boot loader to read the boot code, and a comparator to determine whether the read boot code includes the end code.

The electronic device system may further include a storage unit to store the boot code, and a main memory to receive the boot code from the storage unit when the comparator detects the end code.

The controller may generate and send a boot completion signal and a reset signal to the CPU if the end code of the boot code matches the pre-stored reference end code.

The CPU may execute a system initialization code of the boot code when the CPU is booted, thereby initializing hardware of the electronic device system.

The foregoing and/or other aspects and utilities of the present invention general inventive concept can be also achieved by providing A method of controlling an electronic device system, including loading a boot code in a main memory, executing the boot code from the main memory, and booting a CPU if an end code of the boot code matches a pre-stored reference end code.

The booting of the CPU may include executing a system initialization code of the boot code when the CPU is booted and initializing hardware of the electronic device system.

The foregoing and/or other aspects and utilities of the present invention general inventive concept can be also achieved by providing a computer readable recording medium having embodied thereon a computer program to execute a method, wherein the method includes loading a boot code in a main memory, executing the boot code from the main memory, and booting a CPU if an end code of the boot code matches a pre-stored reference end code.

### BRIEF DESCRIPTION OF THE DRAWINGS

The above and/or other aspects and utilities of the present general inventive concept will become apparent and more readily appreciated from the following description of the embodiments, taken in conjunction with the accompany drawings of which:

FIG. 1 is a schematic control block diagram illustrating an electronic device according to an exemplary embodiment of the present general inventive concept;

FIG. 2 is a detailed control block diagram illustrating the electronic device of FIG. 1 according to the exemplary embodiment of the present general inventive concept; and

FIG. 3 is a control flowchart illustrating a control method of the electronic device of FIG. 1 according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An electronic device according to the present general inventive concept may communicate through a serial peripheral interface (SPI) protocol. The SPI is a synchronous serial data transmission protocol between a host processor and peripheral devices connected to communicate with the host processor. The electronic device according to the present general inventive concept may include a printer, a mobile phone, a navigation device, an MP3 player, a palm computer, a laptop computer, a PC or a device which is booted by a system initialization program (generally called boot code). The electronic device is booted with a power is supplied to the electronic device or when a power switch is on to initialize the electronic device or a system thereof.

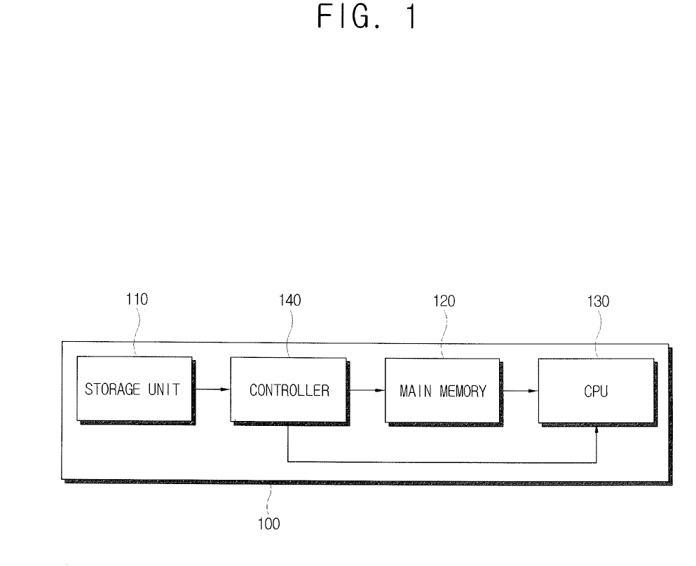

As illustrated in FIG. 1, an electronic device 100 according to an exemplary embodiment of the present general inventive concept includes a storage unit 110, a main memory 120, a CPU 130 and a controller 140 which controls the foregoing elements.

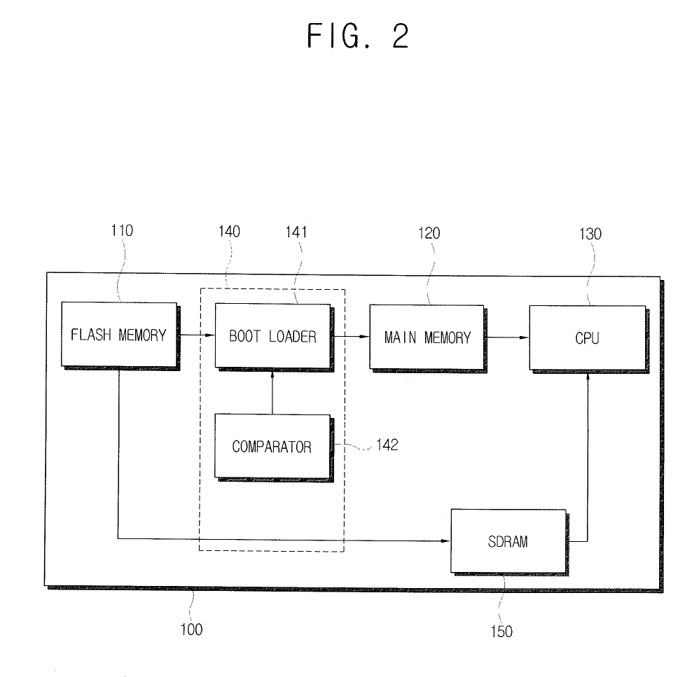

As illustrated in FIG. 2, the storage unit 110 may include a flash memory, and may store a boot code to boot a system and execution codes such as an operation system (OS) and an application program.

The OS may include MS-DOS or WINDOWS, and is executed by a controller to operate the system after the booting or initialization process is completed. The data which is stored in the flash memory may include a configuration code of user storage devices based on a user's request and software codes to use application programs.

The boot code refers to a code to actually boot a system. The boot code is used to initialize hardware of the electronic device, for example, to initialize a main clock of the electronic device, to initialize and manage a memory, to determine whether to use a cache memory of a CPU and to determine how to manage the cache memory, etc. The boot code is also used to copy an application code to a system memory, for example, an SDRAM.

The main memory 120 includes a system memory to which the boot code stored in the flash memory is copied. The main memory 120 may include a volatile memory such as a DRAM. The main memory 120 loads the boot code to make the CPU 130 perform a booting operation.

The CPU 130 performs the booting operation by using the boot code and executes the OS and the application program. Internal data transmission between the main memory 120 and the CPU 130 may be made through a system bus such as advanced microcontroller bus architecture (AMBA).

The controller 140 loads the boot code stored in the storage unit 110, and copies the boot code to the main memory 120 during an initialization stage such as a system power-on stage.

According to the embodiment of FIG. 2, the boot code includes an end code to identify an end of the boot code. The end code may be different from an ARM (Advanced RISC Machine) instruction recognized by the CPU 130.

The boot code is stored in the flash memory before the initialization stage. If the initialization process begins, the controller 140 loads the boot code stored in the flash memory and copies the boot code to the main memory 120. Here, the controller 140 compares the read execution code with a pre-stored reference end code. If the end code is detected in the execution code, the controller 140 generates a boot completion signal and a reset signal, and transmits the reset signal to the CPU 130. Then, the CPU 130 receives the reset signal and initializes the system to be booted.

FIG. 2 illustrates the electronic device according to the exemplary embodiment of the present general inventive concept in more detail. As illustrated in FIGS. 1 and 2, the controller 140 according to an embodiment of the present general inventive concept may include a boot loader 141 which reads the execution codes stored in the flash memory 110, and a comparator 142 which determines whether the read execution codes include the end code.

If the boot request signal such as power supply is applied, the boot loader 141 of the controller 140 loads the execution codes stored in the flash memory 110 and stores the execution codes in the main memory 120. The main memory 120, which stores the boot code therein, is provided within a microcomputer and has a small capacity. For example, the capacity of the main memory 120 may be 4K bytes.

The comparator 142 of the controller 140 compares the loaded execution codes in a unit of a predetermined amount. For example, the reference end code may be set as an arbitrary code, such as 0xff02ff03, which is a 4 byte code. Thus, the comparator 142 compares the loaded execution codes with the reference end code stored in every 4 bytes. For example, the comparator 142 determines whether the loaded execution codes are 0xff02ff03. If it is determined that the loaded execution codes are 0xff02ff03, the comparator 142 generates the boot completion signal. Also, if the comparator 142 detects the end code, the boot loader 141 stops loading the execution codes from the flash memory 110 to the main memory 120.

The CPU 130 receives the reset signal generated with the boot completion signal, and is then activated. The boot code stored in the main memory 120 is executed. The CPU 130 executes a system initialization code of the boot code, thereby initializing the hardware of the system. The CPU 130 executes a copy loop command code of the boot code, thereby loading programs such as OS or other application codes stored in the flash memory 110. The CPU 130 copies the loaded application codes or the programs to an SDRAM 150 as the system memory through an SPI controller and an interface. After the copying operation is completed, the OS or the application program is executed. If the booting operation is completed, the system is driven by the OS from the SDRAM 150.

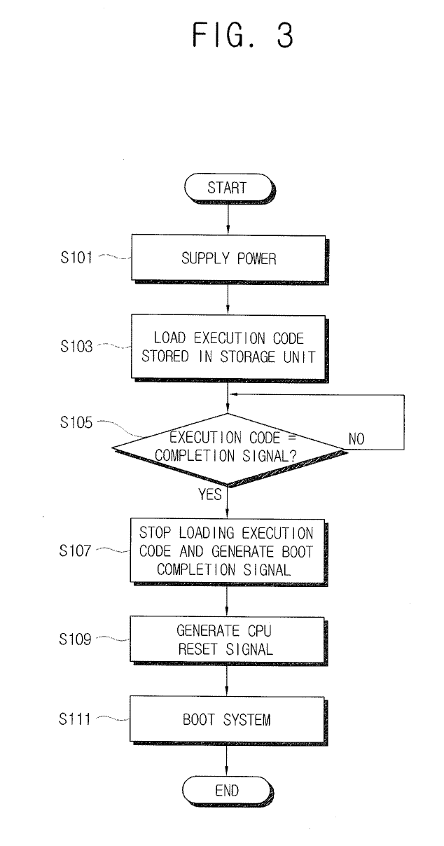

Hereinafter, a booting method of the electronic device 100 according to an embodiment of the present general inventive concept will be described with reference to FIG. 3.

As illustrated in FIG. 3, firstly, power is supplied to the system in operation S101.

In operation S103, the boot loader 141 of the controller 140 loads the execution codes stored in the storage unit 110 and stores the execution codes in the main memory 120.

The comparator 142 of the controller 140 compares the predetermined amount of the execution codes with the reference end code in operation S105. Accordingly, the reference end code may be set as an undefined code to be distinguished from the application code recognized by the CPU 130. For example, the controller 140 may load the execution codes and determine whether an execution code, for example, 0xff02ff03, exists in every 4 bytes.

If the end code is loaded, the controller 140 stops loading and storing the execution codes, generates the boot completion signal in operation S107, and then generates the reset signal in operation S109. Then, the controller 140 transmits the reset signal to the CPU 130.

In operation S111, CPU 130 receives the reset signal to initialize the system, and boots the system with the boot code stored in the main memory 120.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the present general inventive concept provides an electronic device and a control method thereof which can load an actual boot code only, and thus, reduce booting time and prevent malfunction due to unnecessary dummy codes if the boot code is smaller than a size of an internal memory which is performing the loading of the boot code.

Further, time and space to load the unnecessary codes can be saved.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An electronic device, comprising:
a storage unit to store execution codes including a boot code and an application code;
a main memory to load the boot code;
a CPU to perform a booting operation by executing the boot code loaded in the main memory and to execute the application code; and
a controller to read the boot code of the execution codes, to load the boot code to the main memory, and to control the CPU to perform a booting operation if it is determined that the boot code is completely loaded.

2. The electronic device according to claim 1, wherein the boot code comprises a predetermined end code in an end part thereof, and the controller determines that the boot code is completely loaded if the end code is read.

3. The electronic device according to claim 2, wherein the end code is different from the application code executed by the CPU.

4. The electronic device according to claim 3, wherein the controller controls to reset a system and to make the CPU perform booting if the end code is read.

5. The electronic device according to claim 1, wherein the controller communicates with the storage unit and the main memory through a serial peripheral interface (SPI) protocol.

6. The electronic device according to claim 1, wherein the electronic device comprises one of a printer, a mobile phone, a storage device and a navigation device.

7. A method of controlling an electronic device, comprising:
reading a boot code from a storage unit in which execution codes having the boot code and an application code are stored, and loading the boot code to a main memory;
determining whether the boot code is completely loaded; and
executing the boot code stored in the main memory if the boot code is completely loaded, and making a CPU perform booting.

8. The method according to claim 7, wherein the determining whether the boot code is completely loaded comprises:
reading a predetermined end code included in an end part of the boot code.

9. The method according to claim 8, wherein the end code is different from the application code.

10. The method according to claim 9, wherein the performing of the booting comprises:
activating the CPU by resetting a system if the end code is read.

11. The method according to claim 7, wherein the loading of the boot code comprises:
communicating through a serial peripheral interface (SPI) protocol.

12. The method according to claim 7, wherein the electronic device comprises one of a printer, a mobile phone, a storage device and a navigation device.

13. An electronic device system, comprising:
a CPU to execute a boot code from a main memory; and
a controller to load the boot code in the main memory and to boot the CPU if an end code of the boot code matches a pre-stored reference end code.

14. The electronic device system of claim 13, further comprising:
a boot loader to read the boot code; and
a comparator to determine whether the read boot code includes the end code.

15. The electronic device system of claim 14, further comprising:
a storage unit to store the boot code; and
a main memory to receive the boot code from the storage unit when the comparator detects the end code.

16. The electronic device system of claim 13, wherein the controller generates and sends a boot completion signal and a reset signal to the CPU if the end code of the boot code matches the pre-stored reference end code.

17. The electronic device system of claim 13, wherein the CPU executes a system initialization code of the boot code when the CPU is booted, thereby initializing hardware of the electronic device system.

18. A method of controlling an electronic device system, comprising:
loading a boot code in a main memory;
executing the boot code from the main memory; and
booting a CPU if an end code of the boot code matches a pre-stored reference end code.

19. The method of claim 18, wherein the booting of the CPU comprises:
executing a system initialization code of the boot code when the CPU is booted; and
initializing hardware of the electronic device system.

20. A computer readable recording medium having embodied thereon a computer program to execute a method, wherein the method comprises:
loading a boot code in a main memory
executing the boot code from the main memory; and
booting a CPU if an end code of the boot code matches a pre-stored reference end code.
